(19) United States
(12) Patent Application Publication
(10) Pub. No.: US 2024/0147396 A1
(43) Pub. Date: May 2, 2024

(54) METHOD AND APPARATUS FOR MITIGATING PHASE INTERFERENCE OR CANCELLATION BY ALIGNING WAVEFORMS TO 3RD HARMONICS

(71) Applicant: Christopher AMAN, Thompsons’s Station, TN (US)

(72) Inventor: Christopher AMAN, Thompsons’s Station, TN (US)

(21) Appl. No.: 18/497,380

(22) Filed: Oct. 30, 2023

Related U.S. Application Data
(60) Provisional application No. 63/420,929, filed on Oct. 31, 2022.

(51) Int. Cl. H04W 56/00; H04B 1/12; H04R 1/26; H04R 3/14

(52) U.S. Cl. CPC H04W 56/0045; H04B 1/12; H04R 1/26; H04R 3/14

(57) ABSTRACT

Briefly, embodiments of a system and method, and article for receiving an input audio signal. A baseline frequency may be determined. Crossover points may be determined for drivers of a multiway speaker system, where each of the crossover points comprises a multiple of the third harmonic of the baseline frequency. Signal delays may be determined for audio signal components to transmit to the drivers. The audio signal components may be transmitted to the drivers based on the determined signal delays. A composite audio signal may be generated which comprises the audio signal components, by the drivers.

### CROSS REFERENCE

The present application claims priority to U.S. provisional application Ser. No. 63/420,929, which was filed on Oct. 31, 2022, and is entitled “METHOD AND APPARATUS FOR MITIGATING PHASE INTERFERENCE OR CANCELLATION BY ALIGNING WAVEFORMS EMITTED FROM A SINGLE OR MULTIPLE TRANSDUCERS TO 3RD HARMONICS”, the entire content of which is incorporated by reference herein in its entirety.

### BACKGROUND

There are different systems in which different portions of a signal are transmitted, such as audio systems, radar systems, cellular telephone systems, or other types of radio frequency (RF) systems to name just a few examples among many. In some of these systems, a wide range of signal frequencies may be transmitted. In some signal transmission systems, multiple transmitters or other transmission devices may be utilized to transit different frequencies which may combine to form an output composite signal.

If multiple transmitters are utilized to transit different frequencies, there may be interference between the output signals from each of the multiple transmitters. For example, in some instances, there may be destructive interference between the transmitted signals, whereby a portion of a signal transmitted by one of the transmitters effectively cancels a portion of another signal transmitted by a different transmitter, potentially resulting in a relatively weak composite signal and wasted resources.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of a chart of plots of a frequency response of a multiway speaker system in accordance with a phase alignment method.

FIG. 2 illustrates an embodiment of a multiway speaker system.

FIG. 3 illustrates an embodiment of a method for aligning outputs from drivers to multiples of third harmonics of a baseline frequency.

FIG. 4 illustrates an embodiment of a chart of plots of a frequency response of a multiway speaker system in accordance with a 3^{rd} harmonic alignment method.

FIG. 5 illustrates an embodiment of a chart of plots of a frequency response of a multiway speaker system in accordance with an embodiment.

FIG. 6 illustrates an embodiment of a chart of plots of a frequency response of a multiway speaker system in accordance with an embodiment.

FIG. 7 illustrates a signal producing device according to an embodiment.

FIG. 8 illustrates an embodiment of a method for aligning RF signal components for transmission.

FIG. 9 illustrates a system for RF communication between a cell tower and a mobile device according to an embodiment.

FIG. 10 illustrates an example embodiment of an RF transmitter.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art will readily understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded a scope consistent with the principles and features disclosed herein.

In accordance with one or more embodiments, a system and a method are provided for determining crossover points and equalization of a composite signal and time aligning outputs of one or more transducers. For example, the outputs of multiple transducers may be aligned to third harmonics of a particular baseline frequency in order to reduce interference between outputs of the transducers. In accordance with one particular embodiments, the system may comprise a multiway speaker system having multiple drivers for outputting certain ranges of frequencies, where crossover points for signals provided to the drivers are aligned to multiples of the third harmonic of a baseline frequency.

A loudspeaker, which may be referred to herein as a “speaker” or “speaker driver,” comprises an electroacoustic transducer, e.g., a device which converts an electrical audio signal into a corresponding audible sound. A speaker system may include one or more speaker drivers, an enclosure, and electrical connections. The terms “speaker,” “speaker driver,” and “driver” are used interchangeably herein. A driver may comprise a linear motor attached to a diaphragm which couples the linear motor's movement to motion of air to generate audible sounds. An audio signal, such as from a microphone or a recording, may be amplified electronically to a power level capable of driving a motor in order to reproduce the sound corresponding to the original unamplified electronic signal. In the audio industry, there is a desire to use multiway speaker systems when creating audio productions. A “multiway” speaker system, as used herein, refers to a speaker system which comprises two or more drivers, each of which may be configured to emit audio signals within certain frequency ranges.

In one particular embodiment, a multiway speaker system may include three different drivers, such as a high-frequency driver, a mid-frequency driver, and a low-frequency driver. A “high-frequency driver,” or “tweeter,” as used herein, refers to a driver which is designed to produce relatively high audio frequencies, such as between about 2 kHz and 20 kHz, although some high-frequency drivers may produce high frequencies up to about 100 kHz. A “mid-frequency driver,” or “mid-range woofer,” as used herein, refers to a driver which reproduces sound in a midrange frequency range between about 200 Hz to about 2000 Hz. A “low-frequency driver,” or “woofer,” as used herein, refers to a driver designed to produce low frequency sounds, typically within a range of about 20 Hz up to about 200 Hz, although some low-frequency drivers may provide frequencies up to about 4000 Hz.

In one particular embodiment, a multiway speaker system may include multiple different drivers. Each driver may include a vibrating conical diaphragm or cone. For example, a cone of a low-frequency driver may be approximately 10 to 18 inches in diameter, a cone of a mid-frequency driver may be approximately 4 to 8 inches in diameter, and a cone of a high-frequency driver may be approximately 1 to 3 inches in diameter.

A multiway speaker system which includes multiple drivers may selectively split an input audio signal into two or more frequency ranges, so that different portions of the audio signal may be sent to drivers which are designed to operate within different frequency ranges. A “crossover point,” as used herein refers to a frequency at which an input audio signal is split, where certain frequencies within a range below the crossover point are provided to one driver and certain frequencies above the crossover point are provided to a different driver. In a multiway speaker system having three different drivers, such as a high-frequency driver, a mid-frequency driver, and a low-frequency driver, there may be two or more different crossover points. For example, one crossover point may be utilized to indicate which frequencies within a certain range are to be sent to a high-frequency driver and which are to be sent to a mid-frequency driver, and a second crossover point may be utilized to indicate which frequencies within another frequency range are to be sent to a low-frequency driver and which are to be sent to the mid-frequency driver. It should be appreciated that in some multiway speaker systems, there may be more than three different speaker drivers and the total number of crossover points for such a multiway speaker system may be one less than the total number of speaker drivers. For example, where may be multiple drivers in each frequency band. If there are 20 different speaker drivers in a particular multiway speaker system, there may be a total of 19 different crossover points to indicate to which speaker driver certain frequencies are to be provided. A crossover point may be implemented via use of crossover filters. A “crossover filter,” as used herein, refers to a type of electronic filter circuitry which splits an audio signal into two or more frequency ranges. For example, the signal portions from the split audio signal may be sent to speaker drivers that are designed to operate within different frequency ranges. The crossover filters may, for example, be either active or passive filters

A purpose of selecting appropriate crossover points is to divide audio signals to send to the drivers or speakers of a multiway speaker system in such a way so that when the acoustic output of the combination of the drivers reaches a person's ears, that person does not hear interference of output frequencies around the frequency of a crossover point. Such a person may instead hear the audio output combination from the multiway speaker system as if it was from a single driver or speaker.

Selection of appropriate crossover points may have a considerable impact on performance of the multiway speaker system. For example, if a crossover point is selected at a non-ideal frequency, there may be interference between outputs of two or more of the drivers. If a crossover point between frequencies sent to a high-frequency driver and to a mid-frequency driver is not selected at an appropriate frequency, there may be interference between audio emitted by the high-frequency driver and by the mid-frequency driver. If there is a relatively significant amount of signal interference, a resulting audio sound emitted by the multiway speaker system may exhibit cancelation of certain frequencies throughout the audible spectrum. Moreover, in the presence of such signal interference, the amount of power needed to transmit the audio signals may be greater than would be required if there was less interference.

In the current state of the art, crossover points are selected based on the phase and frequency response of speakers. For example, depending on the phase relationship of each frequency emitted by a speaker, there may be different results in amplitude (summation or cancellation) of each frequency on-axis and off-axis. A common step in setting up a sound system is to phase align the main loudspeakers to at least one subwoofer. For example, phases may be aligned in time by introducing delays in the production of sounds out of certain speakers of a system.

Sound technicians and engineers have several methods for combating this issue and creating a predictable response at a chosen spot in a room. One method relates to physical displacement, such as where a measurement is taken at a desired spot for a phase-aligned crossover, a frequency response of reproduced test sound is measured, and crossover points may be selectively moved to different frequencies by a sound engineer until the best results are obtained.

Crossover points in accordance with an embodiment described herein may be selected which are aligned with multiples of the third harmonic of a baseline frequency in order to reduce signal interference between outputs of different drivers. In a particular embodiment, an input audio signal may be received from a source and may be split into different audio signals provided to drivers dedicated to generating audio outputs within certain frequency ranges. For example, portions of an input audio signal may be selectively sent to the different drivers of a multiway speaker system in order to enable the multiway speaker system to produce a composite output audio sound with a relatively small, if any, amount of interference between the audio outputs from the different drivers. In order to produce such a composite audio sound, appropriate crossover points for frequencies split between with different drivers may be selectively determined.

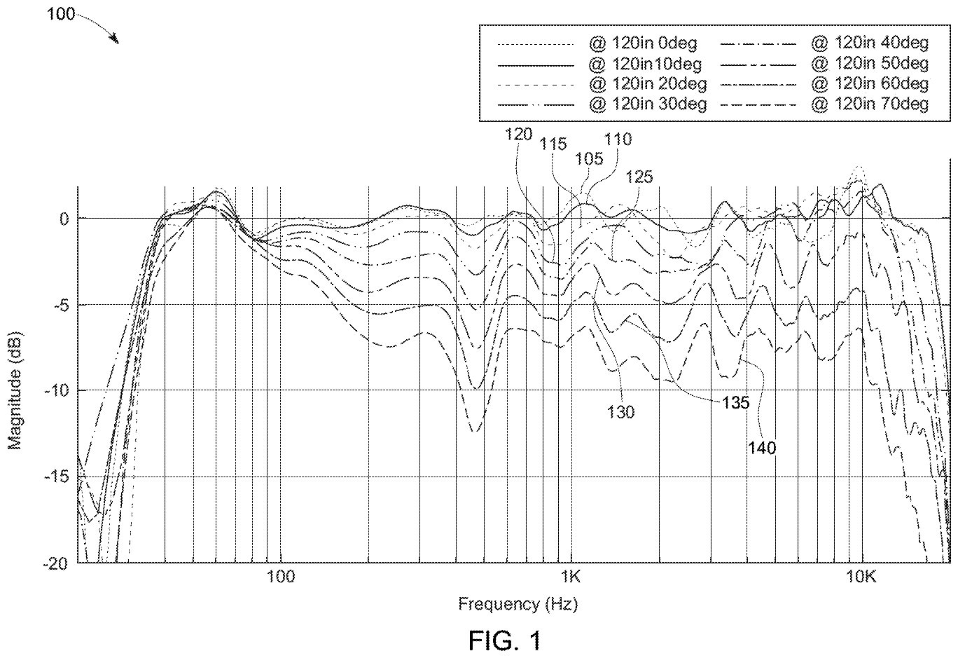

FIG. 1 illustrates an embodiment 100 of a chart of plots of a frequency response of a multiway speaker system in accordance with a phase alignment method. Embodiment 100 illustrates measurements of frequency response of output verses input taken at different positions of a multiway speaker system between about 1 Hz and about 20,000 Hz. For example, there are eight different plots shown, plot 105 is a measurement of the frequency response at 0 degrees off center; plot 110 is a measurement of the frequency response at 10 degrees off center; plot 115 is a measurement of the frequency response at 20 degrees off center; plot 120 is a measurement of the frequency response at 30 degrees off center; plot 125 is a measurement of the frequency response at 40 degrees off center; plot 130 is a measurement of the frequency response at 50 degrees off center; plot 135 is a measurement of the frequency response at 60 degrees off center; and plot 140 is a measurement of the frequency response at 70 degrees off center. In accordance with a particular embodiment, a human operator may utilize a protractor to determine the angles relative to the center of the multiway speaker system. Measurements may be made on planes of 1 meter to 10 feet when measuring a single box.

In one example, pink noise may be provided as an input to a microphone sounded to a multiway speaker system. The frequency response of the pink noise as output by the multiway speaker system may be measured. “Pink noise,” as used herein, refers to an input composite signal which comprises each frequency of the input signal having the same amplitude. “Coherence,” as used herein, refers to a statistic which may be utilized to examine a relationship between two signals or data sets. For example, a measurement of coherence may indicate a magnitude of an output signal reproduced at a particular frequency relative to a magnitude of a corresponding input signal at the same frequency. Coherence may indicate an estimate of power transfer between input and output of the multiway speaker system. In a speaker system which accurately reproduces input signals, the measurement of coherence would be 100%, such that the amount of audio output or reproduced at each observed frequency is equivalent to the amount of audio signal input at each of the observed frequencies. In embodiment 100 of FIG. 1, the coherence for most of the observed frequencies between about 60 Hz and about 12 kHz is close to 100%. However, there is a dip in coherence between around 90 Hz and around 450 Hz where the plots deviate from each other.

Plots 105-140, for example, each exhibit the effects of certain signal cancellations. For example, phase shifts between signals may cause signal cancellation. The phase may change based on the amplitude of frequencies output by each driver. In other words, audio output by different drivers of a multiway speaker system may cancel the audio output by other drivers, resulting in various dips as shown in the plot of embodiment 100. For example, the magnitude of embodiment 100 exhibits dips at around 450 Hz, 3500 Hz, and 6,000 Hz and 9,500 Hz as a result of such phase interactions. Plots 105-140 depict measurements taken at approximately the same volume at plotted degrees on a horizontal plane. These plots show how phase shifts and creates cancellation and changes in the frequency response as one moves off center. The dips shown in plots 105-140 may be caused by phase interference along that plane.

In accordance with an embodiment of the present invention, interference between the audio outputs of different drivers of a multiway speaker system may be reduced relative to that of current speaker systems. In order to reduce such interference, waveforms from each driver may be aligned using a baseline or center frequency (e.g., crossover frequency). For example, two or more transducers may be aligned based on the time of the 3^{rd} harmonic of a chosen baseline frequency.

In one implementation, measurements may be taken from each driver with no filter in to determine what each driver produces. A frequency response is a measurement of a device's magnitude and phase output in response to an input stimulus. A device or system exhibiting a flat response is more accurately reproducing an input through the output without enhancements in a particular area. In other words, a flat response means that what comes in goes out. The flatter the response, the more “pure” the audio is considered to be. A flat frequency response may be important in devices such as loud speakers, monitors and microphones when audio accuracy is desired.

In an implementation of a multiway speaker system having a flat frequency response, the amplitude of frequencies being emitted from each loudspeaker of the multiway speaker system may be approximately the same or within a range of 10% of each other. For example, it may be desirable to have mid-range and high frequencies coming out of their respective drivers at approximately the same magnitude.

In order to generate a flat frequency response in a multiway speaker system, appropriate crossover points may be selected between the different speaker drivers. The output of each speaker driver may be analyzed to determine the capabilities of each driver. If a low frequency driver is determined to be capable of reproducing frequencies as low as 50 Hz, for example, then 50 Hz may be considered a breakpoint or resonant frequency of the low frequency driver. A “cutoff frequency” or “resonant frequency” of a speaker, as used herein, refers to a frequency below which a loudspeaker is increasingly unable to generate sound output for a given input signal. A speaker may be associated with different impedance measurements at different frequencies. Resonance may cause a large increase in impedance and, at a particular higher frequency, a measurement of inductance (or semi-inductance) of voice voices of the speaker may cause impedance to rise again. At resonance, a speaker's impedance may be considered to be pure resistance.

After a cutoff or resonant frequency of a speaker driver has been determined, the cutoff or resonant frequency may be used as a baseline frequency from which to determine crossover frequencies for other drivers. For example, a third harmonic of the baseline frequency may be determined. The third harmonics may comprise a frequency which is three times that of the baseline frequency. Accordingly, if a baseline frequency of a low frequency driver is determined to be 50 Hz, the third harmonic of the low frequency driver may therefore be 150 Hz. An alignment of the crossover points for a particular driver may be made at the third harmonic at the baseline or center frequency.

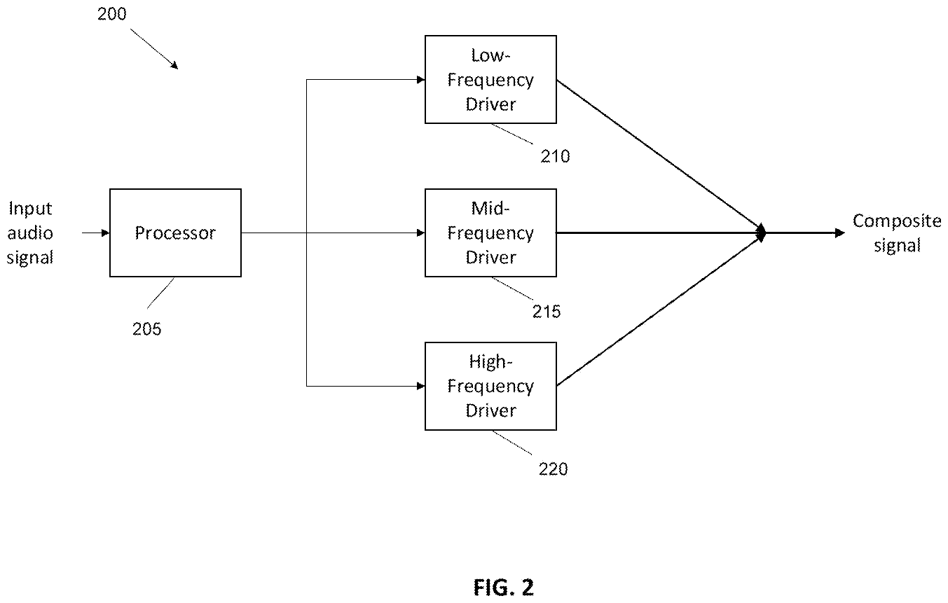

FIG. 2 illustrates an embodiment 200 of a multiway speaker system. In embodiment 200, an input audio signal may be received which is to be output by the multiway speaker system as audio or audible sound. The input audio signal may be received by a processor 205. Processor 205 may be in communication with different drivers, such as low-frequency driver 210, mid-frequency driver 215, and high-frequency driver 220. Low frequency driver 210 may generate a first output audio. Mid-frequency driver 215 may generate a second output audio. High-frequency driver 220 may generate a third output audio. The combination of the first output audio, second output audio, and third output audio comprises a composite audio output which may be heard by one or more persons.

Processor 205 may have information about characteristics of each of the drivers, including a range of output frequencies capable of being generated by each driver. For example, as discussed above, a cutoff frequency for the low-frequency driver 210 may be determined or otherwise known and may be used as a baseline frequency. In some implementations, processor 205 may obtain the characteristics for each of the drivers from a memory or storage device on which such information is stored. After determining the baseline frequency for the low-frequency driver, values of multiples of the third harmonic of the baseline frequency may be determined. For example, if the baseline frequency is determined to be 50 Hz, values of multiples of the third harmonic of the baseline frequency may be identified.

A harmonic is a wave or signal whose frequency is an integral (whole number) multiple of the frequency of the same reference signal or wave. A “third harmonic,” as used herein, refers to a wave or signal which is a multiple of three of a baseline frequency. For example, if the baseline frequency is 50 Hz, the first third harmonic may be a multiple of three of the baseline frequency, or 150 Hz, in this example. The sixth harmonic has a frequency which is twice that of the third harmonic. The sixth harmonic in this example is 300 Hz. Successive multiples of the third harmonic frequency may be determined and a value of the multiple of the third harmonic which is close to a value of a cutoff frequency for a mid-range driver may be selected as a crossover point between the low-frequency driver and the mid-frequency driver. For example, if a cutoff frequency for a mid-range driver is known to be about 275 HZ, a crossover-point may be selected at 300 HZ, which is a value of the 6th harmonic of the baseline frequency. In this example, the 6th harmonic is a multiple of 2 times the 3^{rd} harmonic frequency. Similarly, if a cut-off frequency for a high-range driver is known to be about 2200 HZ, a crossover-point may be selected at 2250 HZ, which is a value of the 45th harmonic of the baseline frequency. In this example, the 45th harmonic is a multiple of 15 times the 3^{rd} harmonic frequency. TABLE A, as shown below, illustrates multiples of the 3^{rd} harmonic of a 50 Hz baseline frequency as well as the length of time for each of the frequencies to complete a single cycle. The selection of the appropriate cross-over points which correspond to multiples of the 3^{rd} harmonic of a baseline frequency may be made manually by a sound engineer or may be made automatically or dynamically, such as via an automated process in some implementations. For example, a processor may execute program code to automatically determine appropriate cross-over points corresponding to the 3^{rd} harmonic of a baseline frequency in accordance with some implementations.

TABLE A
Harmonics of 50 Hz Baseline Frequency

| | | |
|---|---|---|
| Harmonic | Frequency | Length of Time for one cycle |

| | | | | |
|---|---|---|---|---|
| 3^{rd} | 150 | Hz | 6.666 | ms |
| 6^{th} | 300 | Hz | 3.333 | ms |
| 9^{th} | 450 | Hz | 2.222 | ms |
| 12^{th} | 600 | Hz | 1.666 | ms |
| 15^{th} | 750 | Hz | 1.333 | ms |
| 18^{th} | 900 | Hz | 1.111 | ms |
| 21^{st} | 1050 | Hz | .952 | ms |
| 24^{th} | 1200 | Hz | .833 | ms |
| 27^{th} | 1350 | Hz | .741 | ms |
| 30^{th} | 1500 | Hz | .667 | ms |
| 33^{rd} | 1650 | Hz | .606 | ms |
| 36^{th} | 1800 | Hz | .556 | ms |
| 39^{th} | 1950 | Hz | .513 | ms |
| 42^{nd} | 2100 | Hz | .476 | ms |
| 45^{th} | 2250 | Hz | .444 | ms |
| 48^{th} | 2400 | Hz | .417 | ms |
| 51^{st} | 2550 | Hz | .392 | ms |
| 54^{th} | 2700 | Hz | .370 | ms |

By selecting cross-over points as multiples of the 3^{rd} harmonic of the baseline frequency in this manner, an output composite signal may remain in phase and with little or no interference between the outputs of the various drivers. When aligned to the third harmonic, the response of each frequency band stays approximately the same.

In order to ensure that the output signals from each driver remain in phase, a timing delay may be introduced to account for the delay introduced in sending signals to the different drivers. For example, if the baseline frequency is 50 Hz, it may be determined that such a frequency generates 50 cycles per second. Accordingly, it takes 20 ms to perform one cycle at a baseline of 50 Hz. Signals to a mid-frequency driver and to a high frequency driver may each be delayed to account for the time difference for the baseline frequency and for each of the selected third harmonic multiples to complete a full cycle.

Signals provided to the mid-frequency and high-frequency driver may be delayed to ensure that the exit time for audio signals out of each driver is approximately the same. For example, signal delays may be introduced to ensure that the exit times for one cycle of the 50 Hz baseline frequency reproduced from the low-frequency driver, one cycle of the 300 Hz 6th harmonic frequency reproduced by the mid-frequency driver, and one cycle of the 2250 Hz 45^{th} harmonic frequency reproduced by the high-frequency driver are output at approximately the same time.

A reason for introducing these delays is because the low frequency driver takes a longer time to reproduce the baseline frequency because that frequency takes a longer to exit the speaker enclosure. In order to align the drivers, delays may be introduced so that signals at each crossover point frequency are emitted by the drivers of a multiway speaker system at approximately the same time. Accordingly, if a system includes three drivers in a multiway speaker system and there is a first crossover point at the 6th harmonic, 300 HZ, between the low-frequency driver and the mid-range driver and a second crossover point at the 45th harmonic, at 2250 Hz, time delays may be introduced to account for the two crossover points. For example, as shown in Table A, a 2250 Hz signal takes approximately 0.444 ms to perform one full cycle. The time for a signal to perform one full cycle may be determined by dividing the number “1” by the frequency of the signal. In this example, a 2250 Hz signal therefore takes 1/2250 seconds, or approximately 0.444 ms to perform a full cycle. The first crossover point in this example is located at 300 Hz, a signal which takes approximately 3.333 ms to perform one full cycle. Accordingly, because it takes a longer time for a 300 Hz to perform a full cycle than does a 2250 Hz signal, a time delay may be introduced to delay the output of the high frequency driver relative to the mid-range frequency driver. Similarly, it takes a longer time for the baseline 50 Hz baseline signal to perform one cycle by the low-frequency driver. As discussed above, it takes 20 ms for the 50 Hz baseline signal to perform one cycle.

Accordingly, to ensure that audio signals are reproduced at approximately the same time by the different drivers, audio signals sent to the mid-frequency driver and the high-frequency driver may be delayed. For example, a signal to the mid-frequency driver may be delayed by a value of 16.667 ms (e.g., 20 ms-3.333 ms). Similarly, a signal provided to the high-frequency driver may be delayed by a value of 19.556 ms (e.g., 20 ms-0.444 ms).

The introduction of time delays may be performed in order to reduce or eliminate interference between the output signals and to align the outputs to 3^{rd} harmonics of the 50 Hz baseline frequency in this example.

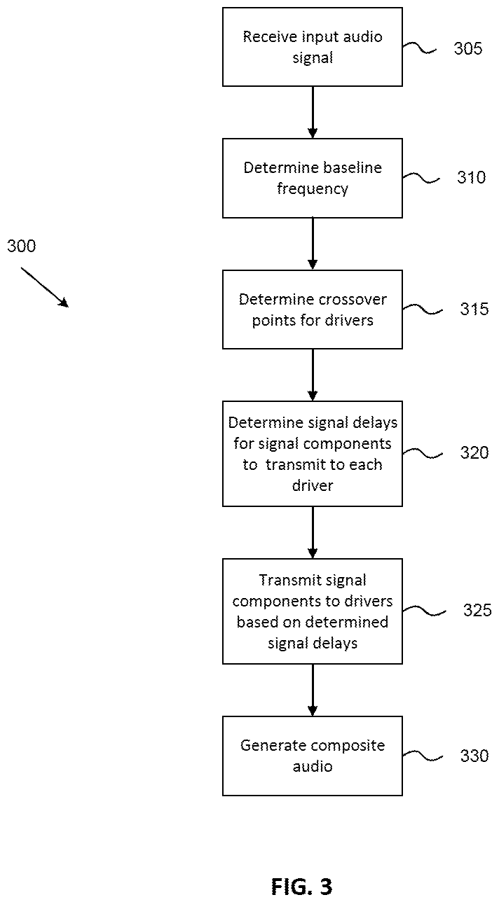

FIG. 3 illustrates an embodiment 300 of a method for aligning outputs from drivers to multiples of third harmonics of a baseline frequency. Such a method of embodiment 300 may be performed by a processor in combination with one or more drivers, for example. Embodiments in accordance with claimed subject matter may include all of, less than, or more than blocks 305 through 330. Also, the order of blocks 305 through 330 is merely an example order.

At operation 305, an input audio signal may be received. At operation 310, a baseline frequency may be determined. As discussed above, the baseline frequency may be determined to be the cutoff frequency of a low-frequency driver in accordance with an embodiment. At operation 320, crossover points may be determined between the drivers. For example, crossover points may be selected which are aligned to multiples of the third harmonic frequency of the baseline frequency. At operation 325, signal delays may be determined for each of the drivers so that audio generated by each driver is aligned in time. At operation 330, the input audio signal may be split at the crossover points and resultant audio signal components are transmitted to the drivers. At operation 330, each of the drivers may process the received audio signal components and may produce an audio output. The audio output of each driver may collectively comprise a composite audio.

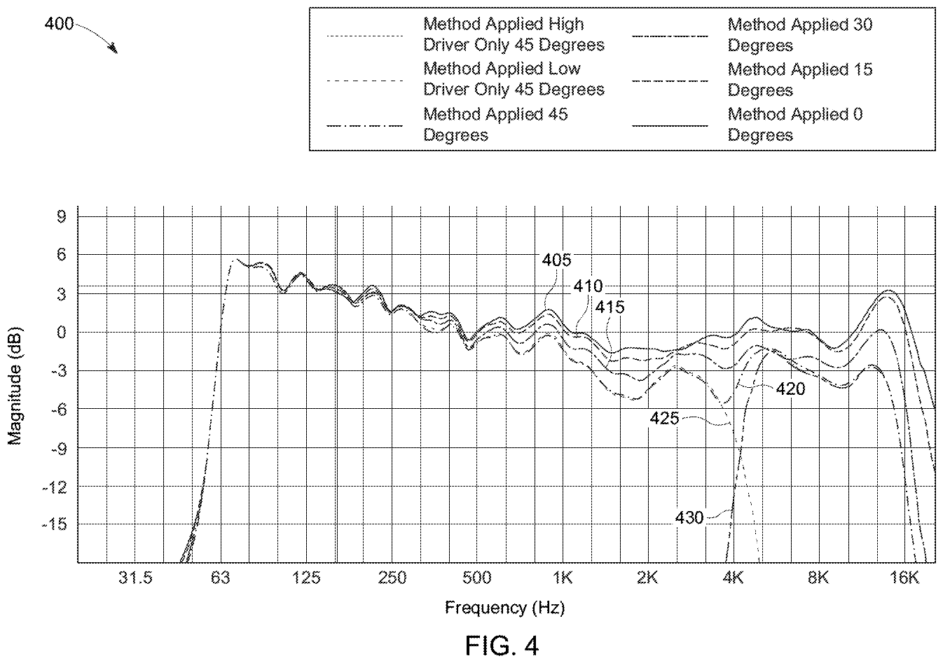

FIG. 4 illustrates an embodiment 400 of a chart of plots of a frequency response of a multiway speaker system in accordance with a 3^{rd} harmonic alignment method such as discussed above with respect to embodiment 300 of FIG. 3. Embodiment 400 illustrates measurements of frequency response of output verses input taken at different positions of a multiway speaker system between about 1 Hz and about 12,000 Hz. For example, there are six different plots shown. Plot 405 is a measurement of the frequency response at 0 degrees off center; plot 410 is a measurement of the frequency response at 15 degrees off center; plot 415 is a measurement of the frequency response at 30 degrees off center; and plot 420 is a measurement of the frequency response at 45 degrees off center. Plot 425 is a measurement of the frequency response of only a high-frequency driver; and plot 430 is a measurement of the frequency response of only the low-frequency driver.

In one example, pink noise may be provided as an input to microphone sounded to a multiway speaker system and the frequency response of the pink noise as output by the multiway speaker system may be measured. In embodiment 400 of FIG. 4.

As shown, the plots of embodiment 400 shown in FIG. 4 exhibits improved coherence relative to the plots of embodiment 100 shown in FIG. 1. By aligning signals to the third harmonic such as is depicted in embodiment 400, signal interference is therefore reduced and signal coherence is simultaneously improved.

In an embodiment, it does not matter how loud or quiet the overall output is as there is little or no phase distortion. Benefits of this system include less interference of audio produced by different speakers and therefore more efficiency.

By introducing time delays in order to align waveforms emitted by different drivers to the 3^{rd} harmonic of a center frequency between 2 bands, various benefits may be realized. For example, the phase interference of signals output by different drivers of a multiway speaker system may be reduced or effectively eliminated in some cases. By reducing such phase interference, the input power to a speaker system may be reduced as the system may operate more efficiently. Moreover, a composite audio sound emitted by a speaker system may exhibit improved acoustic parameters. For example, audio sound may be more pleasing to a human listener and may exhibit less incidence of audio sound distortion.

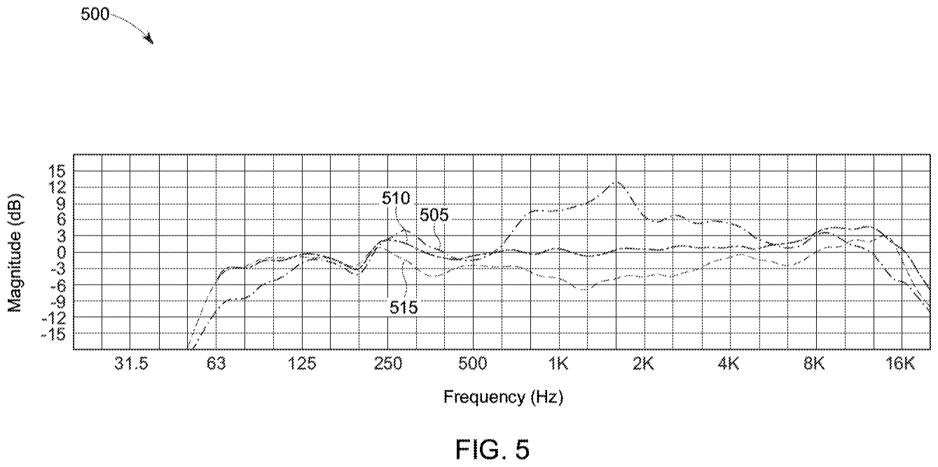

FIG. 5 illustrates an embodiment 500 of a chart of plots of a frequency response of a multiway speaker system in accordance with an embodiment. For example, the multiway speaker system in this example embodiment may comprise a low-frequency driver, a mid-frequency driver, and a high-frequency driver, in an arrangement similar to that shown in embodiment 200 of FIG. 2. The frequency response of embodiment 500 corresponds to a 3-way speaker cabinet and the speaker manufacturer's specifications on the horizontal pattern is 80 degrees or 40 degrees off-axis from zero. The vertical axis in embodiment 500 indicates decibels (dB) and the horizontal axis indicates frequency of an output signal. For example, the chart of embodiment 500 illustrates plots of the volume, in dB, at which each frequency is produced in accordance with different multiway speaker settings.

There are three different plots of frequency responses show in embodiment 500. Plot 515 is a plot of the frequency response for the multiway speaker system if the factory settings for the system are utilized at 0 degrees on axis. In other words, plot 515 shows the frequency response for a multiway speaker system if the crossover points are not changed or otherwise adjusted by an end user from the initial factor settings. The measured dB for frequencies between around 180 Hz and 13,800 Hz for plot 515 trends lower between around 180 Hz and 1,200 Hz and trends higher between around 1,200 Hz and 13,800 Hz. As shown, the dB dips from around 0 dB at around 180 Hz to around −6 dB at around 180 Hz and then rises to about 3 dB at around 13,800 Hz.

Plot 510 shows is a plot of the frequency response for the multiway speaker system if the factory settings for the system are utilized at 30 degrees off axis. As illustrated, there is a peak in plot 510 at around 250 Hz and the measured dB for frequencies between around 250 Hz and around 13,000 Hz for plot 510 is relatively constant, comprising a relatively flat response.

Plot 505 shows is a plot of the frequency response for the multiway speaker system at 0 degrees on axis if the cross-over points between the low-frequency driver and the mid-frequency driver, and between the mid-frequency driver and the high-frequency driver are selected so that they are multiples of the 3^{rd} harmonic of a baseline frequency. In plot 510, the dB increases between a cutoff frequency for the multiway speaker system of around 50 Hz and a peak measurement in dB at slightly above 12 dB at around 1,600 Hz. The dB decreases from the peak measurement at around 1,600 Hz until the maximum measured frequency in plot 505 of around 18,000 Hz. Accordingly, by selecting the crossover frequencies in this example which are multiples of the 3^{rd} harmonic of a baseline frequency and introducing corresponding signal delays, such as discussed above with respect to embodiment 300 of FIG. 4, interference between signals emitted by the different drivers of the multiway speaker system may be reduced, resulting in larger measured mid-range dB values at mid-range frequencies in the chart shown in embodiment 500.

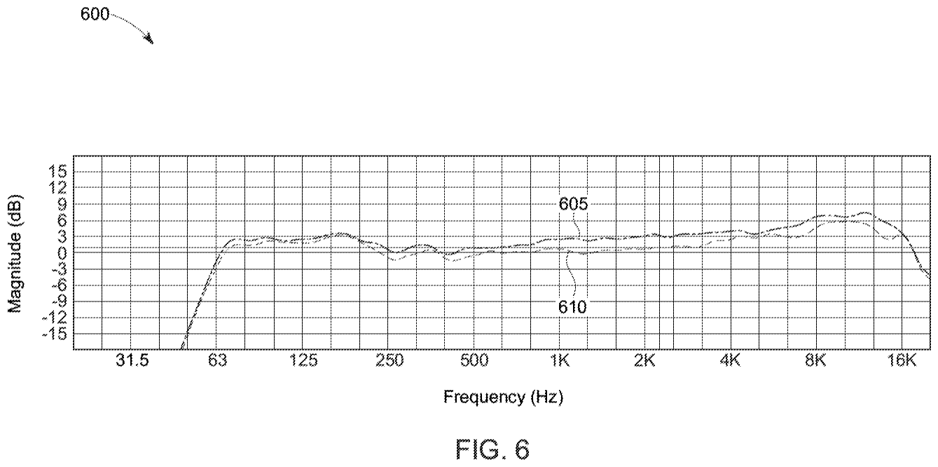

FIG. 6 illustrates an embodiment 600 of a chart of plots of a frequency response of a multiway speaker system in accordance with an embodiment. For example, the multiway speaker system in this example embodiment may comprise a low-frequency driver, a mid-frequency driver, and a high-frequency driver, in an arrangement similar to that shown in embodiment 200 of FIG. 2 and similar to the arrangement discussed above with respect to the chart shown in embodiment 500 of FIG. 5. The frequency response of embodiment 600 corresponds to a 3-way speaker cabinet and the speaker manufacturer's specifications on the horizontal pattern is 80 degrees or 40 degrees off-axis from zero. The vertical axis in embodiment 500 indicates decibels (dB) and the horizontal axis indicates frequency of an output signal. For example, the chart of embodiment 600 illustrates plots of the volume, in dB, at which each frequency is produced in accordance with different multiway speaker settings.

Plot 605 shows the frequency response for the multiway speaker system at 0 degrees on axis if the cross-over points between the low-frequency driver and the mid-frequency driver, and between the mid-frequency driver and the high-frequency driver are selected so that they are multiples of the 3^{rd} harmonic of a baseline frequency and if an equalizer has been applied to generate a relatively flat response. An equalizer may boost or cut (e.g., make louder or softer) a specific range of frequencies to improve sound quality.

Plot 610 shows the frequency response for the multiway speaker system at 30 degrees off axis if the cross-over points between the low-frequency driver and the mid-frequency driver, and between the mid-frequency driver and the high-frequency driver are selected so that they are multiples of the 3^{rd} harmonic of a baseline frequency and if an equalizer has been applied to generate a relatively flat response.

As shown, if cross-over points are selected which are multiples of the 3^{rd} harmonic of a baseline frequency and an equalizer is also used, a relatively flat response may be achieved for an output audio signal.

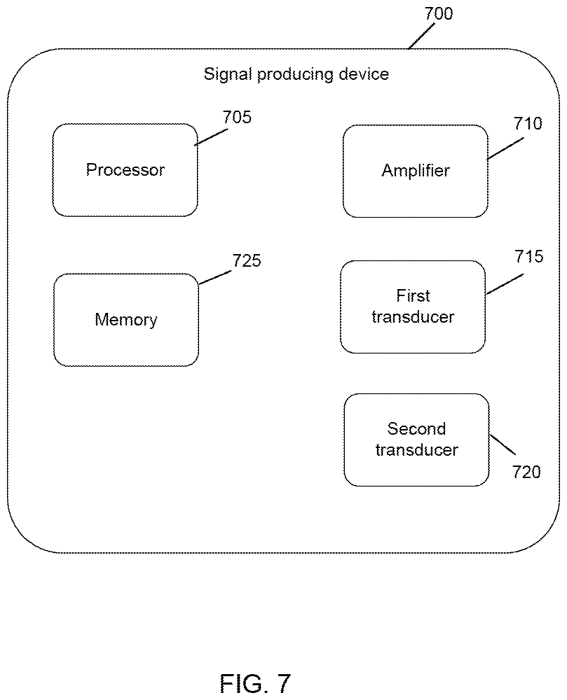

FIG. 7 illustrates a signal producing device 700 according to an embodiment. Signal producing device 700 may include a processor 705. An amplifier 710 may boost or increase a signal to be transmitted. Processor may receive a user input, for example, which comprises the value of one or more crossover points for output signals. Processor 705 may be utilized to process the user input, for example, to determine how to divide an input signal across two or more drivers or transducers, such as first transducer 715 and second transducer 710. For example, first transducer 715 may comprise a low frequency transducer, and second transducer may comprise a high frequency transducer. Processor 705 may execute computer-executable code stored in memory 725. Processor 705 may cause first transducer 715 and second transducer 720 to transform an input signal to output signals, with the sum of the output signals from first transducer 715 and second transducer 720 comprising a composite output signal. For example, an input signal may be provided to amplifier 710. Amplifier 710 may comprise a two-channel amplifier, where the output of a first channel is provided to first transducer 715 and the output of a second channel may be provided to second transducer 720. As discussed above, a cross-over point between the first transducer 715 and the second transducer 720 may be selected, such as based on the user input, such that the cross-over point is a multiple of the 3^{rd} harmonic of a baseline frequency, to reduce destructive interference between signal outputs of the first transducer 715 and the second transducer 720, for example. Although only two transducers are shown in FIG. 7, it should be appreciated that in some implementations, more than two transducers may be employed. It should be appreciated that if a total of N transducers are utilized, amplifier 710 may include N output channels. In some implementations, multiple amplifiers may be utilized, such as where there is a relatively large number of transducers. Moreover, in some embodiment, a controller may be used in combination with processor 705 or in the place of processor 705.

Although embodiments have been described above with respect to a speaker system, it should be appreciated that the teachings discussed above are equally application to other implementations which involve signal processing and/or signal reproduction. For example, there are various radio frequency (RF) implementations which may be improved by aligning the center frequencies of various output RF signals to a 3^{rd} harmonic frequency.

In accordance with an embodiment, if there are three different RF signals to be transmitted at different frequencies, transmission of the higher frequency RF signals may be delayed relative to the transmission of the lower frequency RF signal to, e.g., reduce interference between the transmission of the respective RF signals. For example, if RF signals are to be transmitted at frequencies of 1,000 Hz, 2,000 HZ, and 10,000 Hz, the center frequency between each successive RF signal and the RF signal having the next lowest frequency may be determined and may be utilized to determine by how much to delay transmission of each successive RF signal. In this example, the lowest frequency RF signal, at 1,000 Hz, may be transmitted at time to. The next highest RF signal has a frequency of 2,000 Hz. The center frequency between the 1,000 Hz and 2,000 Hz signals may be determined, which in this case is 1,500 Hz. Transmission of the 2,000 Hz signal may be delayed relative to the transmission of the 1,000 Hz signal by the inverse of the determined center frequency, e.g., 1/(1500 Hz), or 0.666 ms. The next highest RF signal, at 10,000 Hz, may similarly be delayed relative to the transmission of the 2,000 Hz signal based on the center frequency between these RF signals. For example, the center frequency between a 2,000 Hz signal and a 10,000 Hz signal is 6,000 Hz. Therefore, transmission of the 10,000 Hz signal may be delayed by 1/(6,0000 Hz), or 0.166 ms relative to transmission of the 2,000 Hz signal. Accordingly, in the example described above, the 1,000 Hz signal may be transmitted at time to, the 2,000 Hz signal may be transmitted at time to +a delay of 0.666 ms, and the 10,000 Hz signal may be transmitted at time to +a delay of 0.833 ms (0.666 ms+0.166 ms).

Such teachings may be applied within the realm of transmission of RF signals for telecommunications. For example, such teachings may be applicable to communications between a cell phone and one or more cell towers. For example, a cell tower may transmit signals with multiple different frequencies via an antenna and/or a cell phone itself may transmit signals with multiple different frequencies from an antenna.

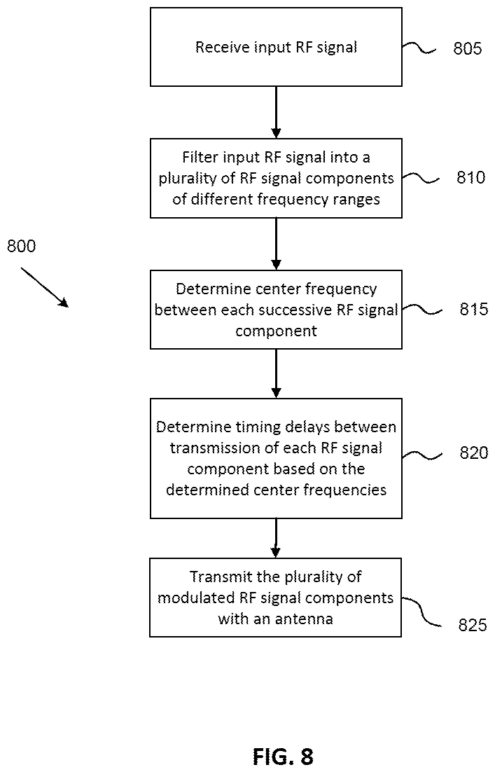

FIG. 8 illustrates an embodiment 800 of a method for aligning RF signal components for transmission. Such a method of embodiment 800 may be performed by a processor in combination with one or more transducers, for example. Embodiments in accordance with claimed subject matter may include all of, less than, or more than blocks 805 through 830. Also, the order of blocks 805 through 830 is merely an example order.

At operation 805, an input RF signal to be transmitted may be received and/or may otherwise be determined. At operation 810, the input RF signal may be filtered into a plurality of RF signal components of different frequency ranges. For example, there may be a plurality of signal filters which filter the input RF signal into multiple different RF signal components, each of which has a different frequency. For example, one RF signal component might have a frequency of about 100 Hz, another RF signal component might have a frequency of 1000 HZ, another RF signal component might have a frequency of about 10,000 HZ, and so forth, to name just a few examples among many.

At operation 815, center frequencies may be determined between each successive RF signal component. For example, if on RF signal component has a frequency of 10 HZ and the next successive RF signal component has a frequency of 100 Hz, a center frequency between these two RF signal components may be 55 Hz, e.g., half of the distance (in terms of frequency) between each of the RF signal components.

At operation 820, timing delays may be determined between transmission of each RF signal component, where the timing delays are based on the center frequencies between each successive RF signal component and the next-lowest RF signal component being transmitted. At operation 825, the plurality of RF signal components may be transmitted via one or more transducers based on the timing delays determined at operation 820. The plurality of RF signal components may be received by an RF receiver and may be demodulated and combined into a signal received RF composite signal.

By delaying transmission of RF signal components based on center frequencies between successive RF signal components and the frequency of the next lowest RF signal component and then transmitting these RF signal components, phase interference and intermodulation may be reduced for a transmitted RF signal.

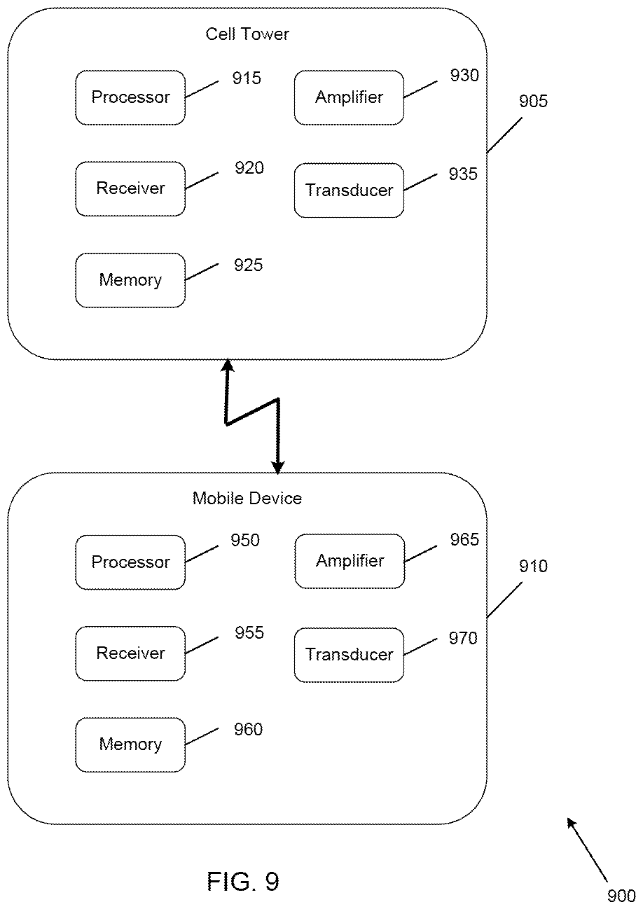

FIG. 9 illustrates a system 900 for RF communication between a cell tower 905 and a mobile device 910 according to an embodiment. Cell tower 905 may include various components, such as a processor 915, a receiver 920, a memory 925, an amplifier 930, and a transducer 935, to name just a few example components among many possible components. Transducer 935 may be considered an antenna which converts electric current into electromagnetic waves or vice versa, for example. It should be appreciated that cell tower 905 may include more than one transducer in some implementations. Receiver 920 may receive one or more signals transmitted by mobile device 910.

As discussed above with respect to embodiment 800 of FIG. 8, an RF signal to be transmitted may be filtered into a plurality of RF signal components of different frequencies. For example, processor 915 may include a filtering capability or may otherwise control one or more other components capable of performing this signal filtering. In one implementation, an RF input signal may be amplified by amplifier 930 and then filtered. Center frequencies between successive RF signal components (e.g., successive in terms of signal frequency) and the next lowest frequency RF signal component may be determined and may thereafter be adjusted so that the adjusted center frequencies are multiples of the 3^{rd} harmonic of a baseline RF signal. By aligning adjusted center frequencies in this manner based on multiples of the 3^{rd} harmonic of a baseline RF signal, destructive interference between signal outputs of the first transducer 935 and the second transducer 940 may be reduced, for example. In some implementations, the adjusted center frequencies may be dynamically selected by processor 915. For example, if a baseline frequency is known or may otherwise be determined for the input RF signal, adjusted center frequencies may be selected or otherwise determined which comprise an optimal 3^{rd} harmonic of the baseline frequency may be selected or otherwise determined by processor 915.

Mobile device 910 may comprise a cell phone, for example. Mobile device 910 may include a receiver 940 to receive one or more signals transmitted by cell tower 905 and/or to receive a user input indicating a cross-over point for signals transmitted by mobile device 910. Mobile device 910 may include various components, such as a processor 950, a memory 955, a memory 960, an amplifier 965, and a transducer 970, to name just a few example components among many possible components. It should be appreciated that mobile device 910 may include more than one transducer in some implementations. As discussed above, center frequencies between RF signal components may be selected which are multiples of the 3^{rd} harmonic of a baseline RF signal or frequency, to reduce destructive interference between the RF signal components during transmission, for example. Received RF signal components may be demodulated and converted into an RF composite signal.

Although transmissions between a cell tower 905 and a mobile device 910 are shown in embodiment 900 of FIG. 9, it should be appreciated that these teachings are also application to other RF applications. For example, RF signal transmissions between a microphone and a headset may implement these teachings, as well as RF communications or transmissions between other types of devices which transmit RF signals.

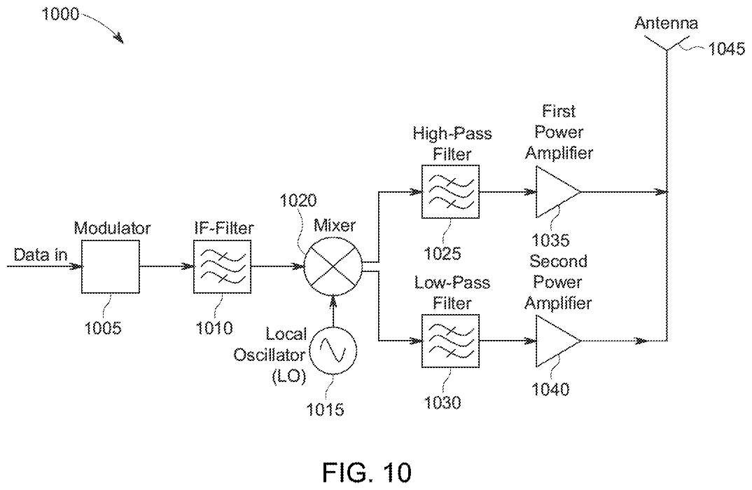

FIG. 10 illustrates an example embodiment 1000 of an RF transmitter. For example, data may be received by a modulator 1005. Modulator 1005 may superimpose a low-frequency (e.g., data or other information) signal onto a high-frequency (carrier) signal for the purpose of wireless transmission. The output of modular 1005 may be provided to an intermediate frequency (IF) filter 1010 which may, for example, compensate for a complex response of high-order filter shapes. The output of IF filter 1010 may be provided to mixer 1020, which mixes the output of the IF filter 1010 with an input frequency signal 1015. The output of mixer 1020 may be provided to both high-pass filter 1025 and a low-pass filter 1030. High-pass filter 1025 may serve to filter out frequencies other than certain high frequencies. Low-pass filter 1030 may serve to filter out frequencies other than certain low frequencies. It should be appreciated that in some implementations, more (or less) than two signal filters may be utilized. The output of high-pass filter 1025 may be provided to first power amplifier 1035. The output of low-pass filter 1030 may be provided to second power amplifier 1040. The first power amplifier 1035 and the second power amplifier 1040 may increase signal strength so that their respective output amplified signals may be transmitted via antenna 1045.

Teachings as discussed here may also be applied within Wi-Fi networks where multiple signals are combined into a composite signal by one or more routers or access points. For examples, such teachings may be applicable to a system which transmits or otherwise processes a waveform and negates phase interference. In one example embodiment, a system in which multiple frequencies are transmitted from the same antenna may benefit from the alignment of different frequencies emitted from the same antenna to a 3^{rd} harmonic of the center frequency between each frequency being used. Such teachings may additionally be applicable within the field of radar.

Although embodiments have been described above with respect to digital signal processing, it should also be appreciated that such teachings are also applicable to analog systems. For example, instead of using a signal processor to introduce time delays in order to align signals output by drivers to the 3^{rd} harmonic of a fundamental frequency, the drivers may be physically positioned in a precise manner so that the output of different drivers located at different positions effectively introduce the time delays.

As will be appreciated based on the foregoing specification, one or more aspects of the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
receiving an input audio signal;
determining a baseline frequency;
determining crossover points for drivers of a multiway speaker system, wherein each of the crossover points comprises a multiple of the third harmonic of the baseline frequency;
determining signal delays for audio signal components to transmit to the drivers;
transmitting the audio signal components to the drivers based on the determined signal delays; and
generating a composite audio signal comprising the audio signal components, by the drivers.

2. The method of claim 1, wherein the baseline frequency is determined based, at least in part, on a cutoff frequency of one of the drivers.

3. The method of claim 1, wherein the signal delays are determined based, at least in part, on the selected crossover points to align signal outputs from the drivers.

4. The method of claim 1, wherein the determining of the crossover points is performed manually.

5. The method of claim 1, wherein the determining of the crossover points is performed automatically.

6. A system, comprising:
one of more drivers of a multiway speaker system to generate audio signal components of a composite audio signal; and
a processor to:
receive an input audio signal;
determine a baseline frequency;
determine crossover points for the one or more drivers, each of the crossover points comprising a multiple of the third harmonic of the baseline frequency;
determine signal delays for audio signal components to transmit to the drivers; and
transmit the audio signal components to the drivers based on the determined signal delays.

7. The system of claim 6, wherein the processor is to determine the baseline frequency based, at least in part, on a cutoff frequency of one of the drivers.

8. The system of claim 6, wherein the processor is to determine the signal delays based, at least in part, on the selected crossover points to align signal outputs from the drivers.

9. The system of claim 6, wherein the processor is to determine the crossover points based on a user input.

10. The system of claim 6, wherein the processor is to determine the crossover points automatically.

11. A method, comprising:
receiving an input radio frequency (RF) signal;
filtering the input RF signal into a plurality of RF signal components;
determining respective center frequencies between each successive RF signal component of the RF signal components;
determining timing delays for transmission of one or more of the RF signal components based on the determined respective center frequencies;
transmitting the RF signal components via one or more transducers based on the determined timing delays.

12. The method of claim 11, wherein the RF signal components comprise portions of a radar signal.

13. The method of claim 11, further comprising transmitting the RF signal components by the one or more transducers of a cell tower.

14. The method of claim 11, further comprising transmitting the RF signal components by the one or more transducers of a mobile device.

15. The method of claim 11, wherein a particular timing delay for a particular RF signal component having a particular frequency comprises the inverse of respective center frequency between the particular RF signal component and another RF signal component having a lower frequency than the particular RF signal component.

16. The method of claim 11, wherein the timing delays are determined automatically.

17. The method of claim 11, wherein the timing delays are determined manually.
